(19) United States
(12) Patent Application Publication
(10) Pub. No.: US 2024/0136690 A1
(43) Pub. Date: Apr. 25, 2024

(54) ELECTROLYTE INJECTION DEVICE

(71) Applicant: Samsung SDI Co., Ltd., Yongin-si (KR)

(72) Inventors: Back Gun KIM, Yongin-si (KR); Sun Wook KIM, Yongin-si (KR)

(21) Appl. No.: 18/466,532

(22) Filed: Sep. 12, 2023

(30) Foreign Application Priority Data
Oct. 19, 2022 (KR) 10-2022-0135730

(51) Int. Cl. H01M 50/609; H01M 50/673

(52) U.S. Cl. CPC H01M 50/609; H01M 50/673

(57) ABSTRACT

A liquid injection device includes a liquid injector including a liquid injection hopper connected to a storage tank configured to store an electrolyte and a valve including an injection nozzle connected to the liquid injector to inject the electrolyte into a cell. The injection nozzle includes a conical body and an injection part protruding from an end of the body, and the injection part includes an obstacle. A shape of the liquid injection nozzle may be changed to disperse an injection pressure of the electrolyte, and damage such as scratches in a top surface of the electrode assembly may be avoided.

### CROSS-REFERENCE TO RELATED APPLICATION

This application claims priority to and the benefit of Korean Patent Application No. 10-2022-0135730, filed on Oct. 20, 2022 in the Korean Intellectual Property Office, the entire disclosure of which is incorporated herein by reference.

### BACKGROUND

### 1. Field

Aspects of embodiments of the present disclosure relate to a liquid injection device.

### 2. Description of the Related Art

A secondary battery includes a case provided with an electrode assembly, which includes a positive electrode, a negative electrode, and a separator interposed between the positive electrode and the negative electrode, and an electrolyte impregnated in the electrode assembly.

In general, in a process of manufacturing a secondary battery, after an electrode assembly is inserted into a case, a process of sealing the case after an injection process of injecting an electrolyte to complete an assembly of the secondary battery is performed.

To inject the electrolyte, a liquid injection device for injecting a liquid by applying a pressure at high pressure is mainly used. As a result, marks (e.g., scratches, dents, holes, etc.) may occur in a top surface of the electrode assembly due to the pressure at which the electrolyte is injected.

The above-described information disclosed in the technology that serves as the background of the present disclosure is provided for improving understanding of the background of the present disclosure and, thus, may include information that does not constitute the related art.

### SUMMARY

According to an aspect of embodiments of the present disclosure, a liquid injection device having an improved structure of a liquid injection nozzle is provided. According to another aspect of embodiments of the present disclosure, a liquid injection device capable of dispersing an injection pressure as an electrolyte is injected is provided.

According to one or more embodiments, a liquid injection device includes: a liquid injector including a liquid injection hopper connected to a storage tank configured to store an electrolyte; and a valve including an injection nozzle connected to the liquid injector to inject the electrolyte into a cell, wherein the injection nozzle includes: a conical body; and an injection part protruding from an end of the body, and the injection part includes an obstacle.

The obstacle may have a spiral shape located on an inner circumferential surface of the injection part.

The obstacle may include a vane structure located inside the injection part.

The obstacle may include at least one rib structure located on an end of the injection part.

### BRIEF DESCRIPTION OF THE DRAWINGS

The accompanying drawings are included to provide a further understanding of the present disclosure, and are incorporated in and constitute a part of this specification.

The drawings illustrate some example embodiments of the present disclosure and, together with the description, serve to explain principles of the present disclosure. In the drawings:

FIG. 1 illustrates a schematic view of a liquid injection device according to an embodiment;

FIGS. 2A and 2B illustrate views of a liquid injection nozzle of the liquid injection device of FIG. 1, according to an embodiment;

FIGS. 3A and 3B illustrate views of a liquid injection nozzle of the liquid injection device of FIG. 1 according to another embodiment; and

FIGS. 4A and 4B illustrate views of a liquid injection nozzle of the liquid injection device of FIG. 1 according to another embodiment.

### DETAILED DESCRIPTION

Herein, some example embodiments of the present disclosure will be described in further detail with reference to the accompanying drawings. Embodiments of the present disclosure may, however, be embodied in many different forms and should not be construed as being limited to the embodiments set forth herein; rather, these embodiments are provided so that this disclosure will be thorough and complete, and will fully convey the scope of the present disclosure to those skilled in the art.

In addition, in the following drawings, the thickness or size of each layer may be exaggerated for convenience and clarity of description, and the same reference numerals in the drawings refer to the same elements. As used herein, the term “and/or” includes any and all combinations of one or more of the associated listed items. In this specification, it is also be understood that when a member A is referred to as being connected to a member B, the member A may be directly connected to the member B or indirectly connected to the member B with one or more members C therebetween.

The terms used in this specification are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise/include” and/or “comprising/including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these.

As used herein, terms such as “first,” “second,” etc. are used to describe various members, components, areas, layers, and/or portions. However, the members, components, areas, layers, and/or portions are not to be defined by these terms. The terms do not mean a particular order, up and down, or superiority, and are used for distinguishing one member, component, area, layer, or portion from another member, component, area, layer, or portion. Thus, a first member, component, area, layer, or portion which will be described may also refer to a second member, component, area, layer, or portion, without departing from the teachings of the present disclosure.

Spatially relative terms, such as “below,” “beneath,” “lower,” “above,” “upper,” and the like, may be used herein for ease of description to describe one element or feature's relationship to another element(s) or feature(s) referring to the figures. These spatially relative terms are intended for ease of comprehension of the present invention according to various process states or usage states of the present invention, and, thus, the present disclosure is not limited thereto. For example, if an element or feature shown in the drawings is inverted, the element or feature described as “beneath” or “below” may change into “above” or “upper.” Thus, the term “lower” may encompass the term “upper” or “below.”

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

Herein, a liquid injection nozzle and a liquid injection device according to embodiments of the present disclosure will be described in further detail with reference to the accompanying drawings.

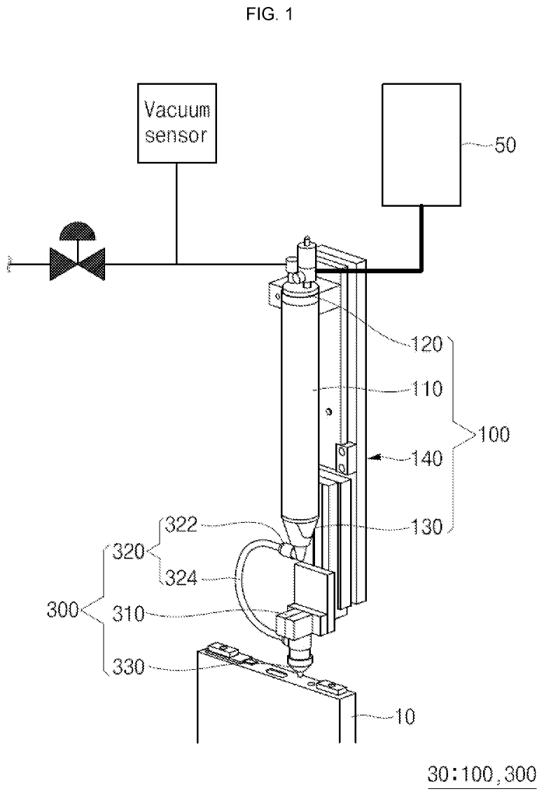

FIG. 1 illustrates a schematic view of a liquid injection device according to one or more embodiments.

Referring to FIG. 1, a liquid injection device 30 may be a device of an automation facility for injecting an electrolyte into a secondary battery cell 10. The liquid injection device 30 according to embodiments of the present disclosure may include a liquid injection unit, or liquid injector, 100 and a valve unit, or valve, 300.

The electrolyte may be supplied from a storage tank 50, which stores the electrolyte, to the liquid injection unit 100. In an embodiment, the storage tank 50 may have a pressure environment that is the same as atmospheric pressure and may supply the electrolyte to the liquid injection unit 100 by its own weight. Although not shown in the drawing, a device that generates a vacuum and generates a pressure for injecting the electrolyte at a high pressure such as a vacuum pump may be connected to the liquid injection unit 100. Additional components, such as a vacuum sensor and a check valve, may be connected to the liquid injection unit 100 to realize connection of the pressure generating device, pressure detection, and leakage detection.

The liquid injection unit 100 may include a liquid injection hopper 110, to which a liquid injection head 120 and a liquid injection nozzle 130 are coupled, and a hopper support 140 supporting the liquid injection hopper 110 and the valve unit 300.

In an embodiment, the liquid injection hopper 110 may have a cylindrical pipe shape, and the inside of the liquid injection hopper 110 may be open such that upper and lower ends thereof communicate with each other. The liquid injection hopper 110 may serve as a reservoir for temporarily storing the electrolyte before injecting the electrolyte into the cell 10. The liquid injection head 120 may be coupled to the upper end of the liquid injection hopper 110, and the liquid injection nozzle 130 may be coupled to the lower end of the liquid injection hopper 110.

The liquid injection head 120 may be coupled to the upper end of the liquid injection hopper 110 and connected to the storage tank 50 storing the electrolyte by an electrolyte transfer line. In an embodiment, a vacuum valve for vacuuming the inside of the liquid injection hopper 110, a vacuum sensor for checking a vacuum state, and a liquid injection valve for adjusting an amount of injection of the electrolyte may be installed in the liquid injection head 120. The electrolyte may be supplied to or blocked from the liquid injection hopper 110 by opening and closing the liquid injection valve.

The liquid injection nozzle 130 may have an upper end coupled to the liquid injection hopper 110 and a lower end connected to the valve unit 300. The liquid injection nozzle 130 may have a conical shape of which a diameter gradually decreases downward from an upper portion thereof. The electrolyte supplied to the liquid injection hopper 110 may be transferred to the valve unit 300 through the liquid injection nozzle 130.

The hopper support 140 may fix and support the liquid injection hopper 110. In an embodiment, the hopper support 140 may be coupled to an installation surface, such as a wall surface or a separate support structure. In an embodiment, the hopper support 140 may include a structure such as a support rail for slidably supporting the valve unit 300 at a lower side of the liquid injection hopper 110 in a longitudinal direction, but is not limited thereto.

In an embodiment, the valve unit 300 may include a valve support 310 movably coupled to the hopper support 140, a connection part 320 connected to the liquid injection nozzle 130, and an injection nozzle 330 for injecting the electrolyte into the cell 10.

The valve support 310 may be movably coupled to a lower portion of the hopper support 140 to allow the injection nozzle 330 to move in a longitudinal direction of the liquid injection hopper 110 (e.g., a vertical direction in FIG. 1). In an embodiment, the valve support 310 may include a motor, an actuator, a hydraulic cylinder, and the like, and a structure supporting the above-described components. In an embodiment, the valve support 310 may be configured such that the valve support 310 supports the injection nozzle 330 to move vertically.

The connection part 320 may include a connector 322 and a tube 324 made of a flexible material having an opening therein. The connector 322 may serve to connect each of the liquid injection nozzle 130 and the injection nozzle 330 to the tube 324. One end of the tube 324 is fixed to the liquid injection nozzle 130, and the other end of the tube 324 is fixed to the injection nozzle 330, and, because the injection nozzle 330 moves vertically, the tube 324 may be made of a flexible material.

The injection nozzle 330 may have a conical shape of which a diameter gradually decreases downward from an upper portion thereof. A lower end of the injection nozzle 330 may have a diameter that is sufficient to cover an injection hole of the cell 10. In one or more embodiments, the injection nozzle 330 maintains a state of being in close contact with the injection hole of the cell 10. In one or more embodiments, the injection nozzle 330 may have rigidity so as to be maintained in its shape, but if pressed by external force, slight elastic deformation may occur such that the injection nozzle 330 covers the injection hole of the cell 10 and has elasticity capable of adhering to the top surface of the cell 10. In one or more embodiments, the injection nozzle 330 may be made of a material such as soft plastic or rigid rubber or silicon. In one or more embodiments, the injection nozzle 330 may be provided (e.g., separately provided) with an injection part 334 protruding from a lower end so as to be easily in close contact with the injection hole of the cell 10.

Herein, various embodiments of the injection nozzle described above will be further described.

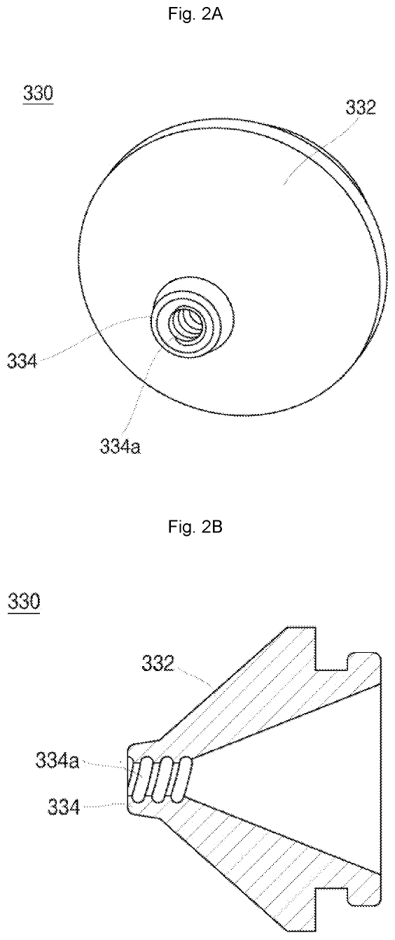

FIGS. 2A and 2B illustrate views of the liquid injection nozzle of the liquid injection device of FIG. 1 according to an embodiment.

Referring to FIGS. 2A and 2B, the injection nozzle 330 according to one or more embodiments of the present disclosure may include a conical body 332 and an injection part 334 protruding in a cylindrical shape from a lower end of the conical body 332. In an embodiment, both the inside and outside of the conical body 332 may be conical. The injection part 334 may communicate with the conical body 332, and an obstacle 334a may be disposed on an inner circumferential surface of the injection part 334. The obstacle may be a continuous spiral structure on the inner circumferential surface of the injection part 334. The spiral structure may serve as an obstacle to rotate and inject the electrolyte as the electrolyte is injected, thereby reducing an injection pressure.

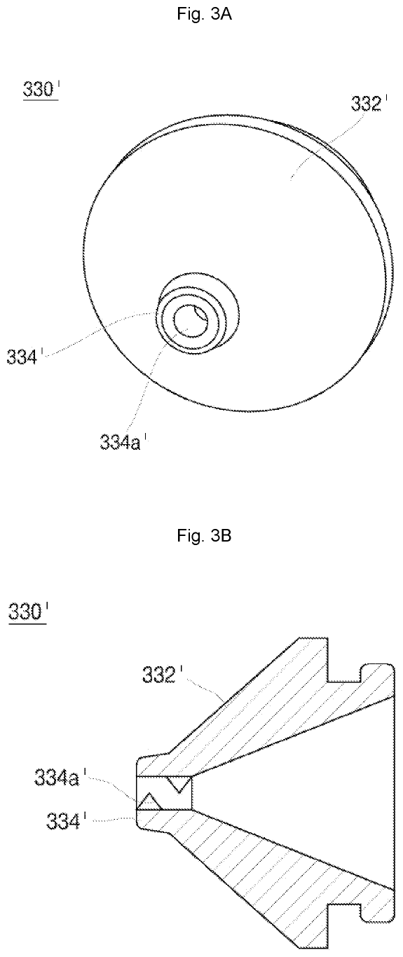

FIGS. 3A and 3B illustrate views of a liquid injection nozzle of the liquid injection device of FIG. 1 according to another embodiment.

Referring to FIGS. 3A and 3B, an injection nozzle 330′ according to another embodiment of the present disclosure may include a conical body 332′ and an injection part 334′ protruding in a cylindrical shape from a lower end of the conical body 332′. In one or more embodiments, a shape of the body 332′ may be substantially the same as in the embodiment of FIGS. 2A and 2B, except that an obstacle 334a′ such as a vane structure may be provided on an inner circumferential surface of the injection part 334′. This structure may reduce an injection pressure by changing a moving direction of an electrolyte due to the obstacle being arranged in a flow path of the electrolyte.

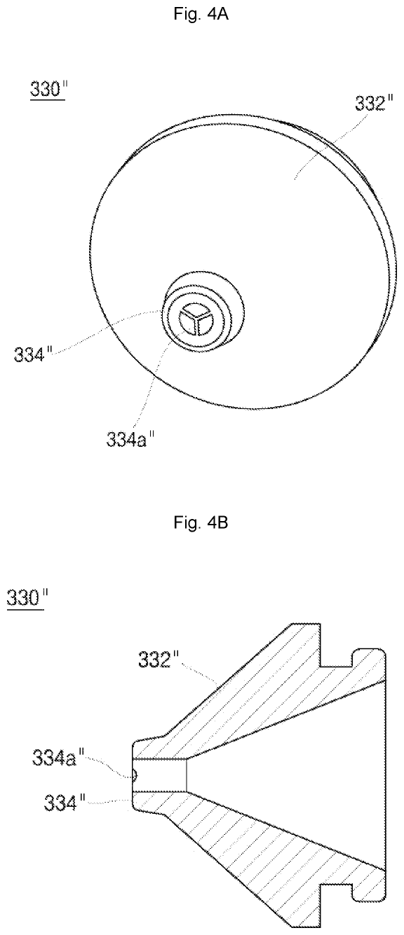

FIGS. 4A and 4B illustrate views of a liquid injection nozzle of the liquid injection device of FIG. 1 according to another embodiment.

Referring to FIGS. 4A and 4B, an injection nozzle 330″ according to another embodiment of the present disclosure may include a conical body 332″ and an injection part 334″ protruding in a cylindrical shape from a lower end of the conical body 332″. In one or more embodiments, a shape of the conical body 332″ may be substantially the same as in the embodiments of FIGS. 2A and 2B, except that an obstacle 334a″ such as a rib may be provided on an injection end of the injection part 334″. A shape of the rib may be provided in any of various shapes, such as a straight bar shape, a cross shape, and a plurality of bar shapes. This structure reduces an injection pressure by allowing an electrolyte to be dispersed and injected.

Because the injection pressure of the electrolyte is reduced by the shape of the injection nozzle having various structures described above, if the electrolyte is injected, dents, grooves, scratches, etc., may not occur due to collision with the electrode assembly. Therefore, the electrode assembly may be prevented or substantially prevented from being damaged by the injection pressure as the electrolyte is injected.

According to one or more embodiments of the present disclosure, the shape of the liquid injection nozzle may be changed to disperse the injection pressure of the electrolyte. In some embodiments, damage, such as scratches in the top surface of the electrode assembly, may be prevented or substantially prevented from occurring.

While some embodiments of the present invention have been described herein, the present invention is not limited to the foregoing embodiments, and it will be understood by those of ordinary skill in the art that various changes in form and details may be made therein without departing from the spirit and scope of the present invention as set forth by the following claims.

What is claimed is:

1. A liquid injection device comprising:
a liquid injector comprising a liquid injection hopper connected to a storage tank configured to store an electrolyte; and
a valve comprising an injection nozzle connected to the liquid injector to inject the electrolyte into a cell,
wherein the injection nozzle comprises:
a conical body; and
an injection part protruding from an end of the body,
wherein the injection part comprises an obstacle.

2. The device as claimed in claim 1, wherein the obstacle has a spiral shape located on an inner circumferential surface of the injection part.

3. The device as claimed in claim 1, wherein the obstacle comprises a vane structure located inside the injection part.

4. The device as claimed in claim 1, wherein the obstacle comprises at least one rib structure located on an end of the injection part.
